(19) United States
(12) Patent Application Publication
(10) Pub. No.: US 2014/0136275 A1
(43) Pub. Date: May 15, 2014

(54) BEHAVIORAL DATA DRIVEN RECOMMENDATION

(71) Applicant: Spiceworks, Inc., Austin, TX (US)

(72) Inventors: David Rathmann, Austin, TX (US); Francis Sullivan, Austin, TX (US); Scott Abel, Austin, TX (US)

(21) Appl. No.: 13/861,340

(22) Filed: Apr. 11, 2013

Related U.S. Application Data
(60) Provisional application No. 61/622,884, filed on Apr. 11, 2012.

(51) Int. Cl. G06Q 30/06; G06Q 10/06; G06Q 30/02

(52) U.S. Cl. CPC G06Q 30/0631; G06Q 30/0201; G06Q 10/0633
USPC 705/7.27

(57) ABSTRACT

A method and computer readable medium for a fully integrated IT recommendation system, comprising receiving contextual data comprising information regarding what a user is currently viewing; receiving relational data information regarding the user's previous interaction with an online community related to IT administrators; receiving market view data comprising industry trend information related to IT, the industry particular to the user's industry. The contextual data, the relational data, and the marketing data make up the workflow context. The workflow context is passed to a recommendation engine which evaluates the workflow context and selects one or more of a set of outcomes, the outcome(s) are directly related to the workflow context; and presenting said one or more selected outcomes to said user.

### CROSS-REFERENCE TO RELATED APPLICATIONS

This application claims the priority of U.S. Provisional No. 61/622,884 filed on Apr. 11, 2012 and entitled “BEHAVIORAL DATA DRIVEN RECOMMENDATION.”

### FIELD OF THE INVENTION

The invention related to a comprehensive system and method for making recommendations to a user based on a combination of active and collected data.

### BACKGROUND OF THE DISCLOSED SUBJECT MATTER

Existing recommendation engines are computationally intractable. This is because existing systems attempt to map a known set of data to an unknown set of outcomes. Furthermore, even if existing systems could overcome the above problem, there are limited sets of data on which the system can evaluate to provide recommendations. This results in poor recommendations and eventual obsolescence.

### BRIEF DESCRIPTION OF THE DISCLOSED SUBJECT MATTER

The disclosed subject matter provides a comprehensive system and method for making recommendations to a user based on a combination of active and collected data. More specifically, in combination with an online network management system, the disclosed subject matter bases its recommendations on (i) information related to the IT devices used on a network; (ii) network events; (iii) relational data; and/or (iv) contextual data.

### BRIEF DESCRIPTION OF THE FIGURES

FIG. 1 depicts an embodiment of a contextual data system architecture.

FIG. 2 depicts an embodiment of a system architecture overview for presenting a recommendation to an IT Administrator.

FIG. 3 depicts an embodiment of a system architecture showing the flow of information for rating/scoring recommendations.

FIG. 4 depicts an embodiment of a general interface, or “Dashboard,” of an online network management system.

FIG. 5 depicts a recommendation, tip, or outcome presented to a user of the online network management system.

FIG. 6 depicts an embodiment of the See Device Details tab.

FIG. 7 depicts an embodiment of the See Application Details.

FIG. 8 depicts an embodiment of community message board posts relating to the recommendation/tip/outcome of FIG. 5.

FIG. 9 depicts an embodiment of an Inventory screen displaying all devices and information about all devices on the network.

FIG. 10 depicts a recommendation/tip/outcome presented to a user in a pop-up screen on the Inventory tab.

FIG. 11 depicts an embodiment of community message board posts provided to the user after the “See what the community has to say” tab has been selected.

### DETAILED DESCRIPTION

The disclosed subject matter provides a comprehensive system and method for making a recommendation to a user based on a combination of active and collected data. Recommendations are a way to find relevant information in the form of outcomes to provide to the user. Driven from behavioral data, among other types of data, recommendations allow the contextual application disclosed herein to grow and adapt to the specific preferences of each individual user using the application. The recommendation may be a pro-active recommendation provided to the user based on information collected by the online network management system and/or based on the user's desktop interface actions. This recommendation is described in the form of an IT Device (e.g. software, services, an IT product, etc.) recommended to an IT administrator utilizing an online network management system; however, one skilled in the art may apply the system and methods disclosed herein to make various types of recommendations including those relating to non-technology items/services. Further, the terms recommendation or tip are used herein as an outcome presented to the user but a recommendation should not be limited to an item or solution for purchase; a recommendation may also include any type of suggestion or outcome based on relational data and contextual information concerning the user.

Disclosed in the descriptive text below and in the corresponding figures are exemplary aspects, features, and functionalities that may comprise a behavioral driven system and/or method; however, one may apply any combination of the disclosed features and/or additional features to the innovations disclosed herein. Screenshots are utilized to help describe the features and functionality as well as underlying architecture of the system. The disclosed subject matter may also include an online network management system such as that described in U.S. Pat. Pub. No. 2010/0100778, filed on Jan. 23, 2009 by common inventor Francis Sullivan, which is hereby incorporated by reference in its entirety.

The disclosed subject matter tracks and stores contextual data of one or more users using a computing system in combination with data captured relating to the user's network—which may be provided by an online network management system such as that disclosed in U.S. Pat. Pub. No. 2010/0100778. Thus, the disclosed subject matter combines information relating to the IT devices used on a network (hardware, software, including the interconnectivity of the same, etc.), network events (e.g. the current status of IT devices), relational data (e.g. other community members/users the user has connected to or message board questions the user has viewed), and contextual data (e.g. what the user is presently viewing). As previously alluded to the system may comprise an online community component which is especially helpful with relational data tracking and analysis. All of these components are fully integrated to determine and provide a user with recommendations.

### Events

Event data comprises network events—in other words, the status of IT devices on the network. Examples of event data include the current status of disk space available on a device, the memory utilization, network utilization, software installation or removal, power fluctuations, warranty expiration, etc.

### Relational Data

Relational data includes information concerning past connections the user has made in the community component. Some examples of relational data include other network users (IT Admins) the user has connected to, questions/posts the user has read on the community message boards, surveys the user had participated in or created, etc.

### Context

Context, or contextual data, comprises the current set of information that the user is viewing. For example, if the user is viewing a Dell® (a registered trademark of Dell Computer Corporation) laptop on an inventory page of an online network management system then the context is the Dell® laptop and everything about the laptop. Context may also include to some extent the environment that the Dell® laptop operates in (e.g. the network).

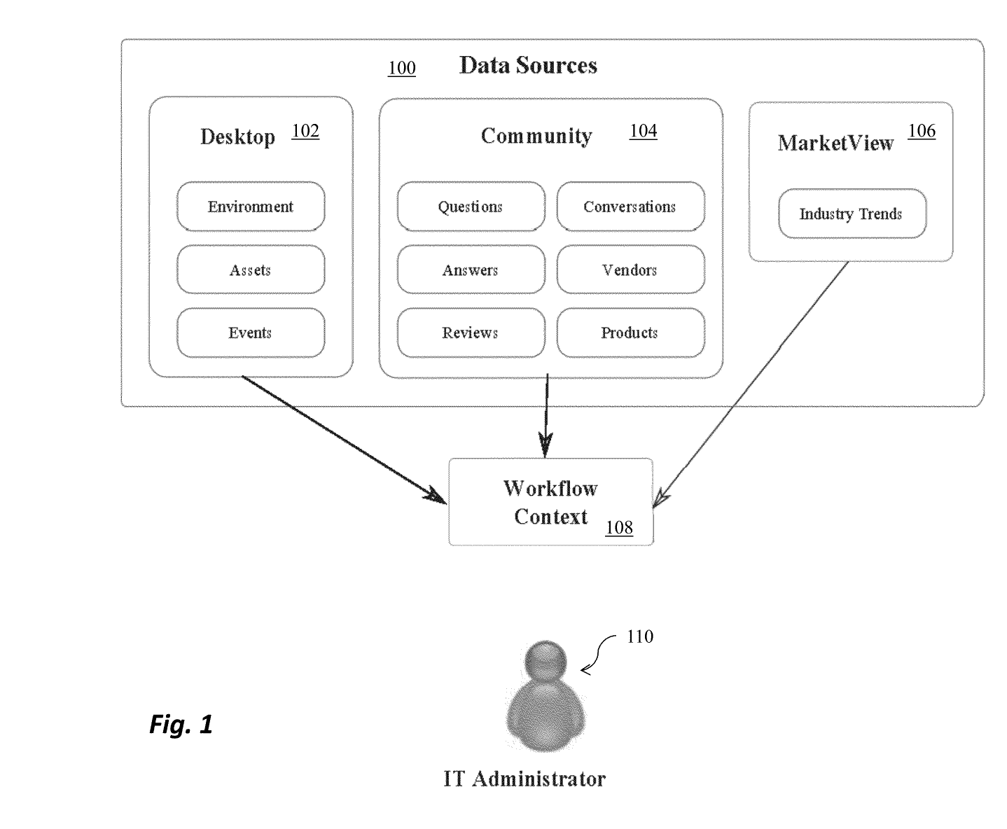

Referring now to FIG. 1 which depicts an embodiment of a contextual data system architecture. Context may be a hybrid application. In one embodiment, the desktop application 102 is installed on-device behind the user's firewall and runs in the context of her network and other contextual data collectors (such as a community component 104 collecting the user's network community actions and market component 106 collecting industry trend information) are traditional web applications that run in hosted data centers. Thus, the user data 100 such as her view of the desktop is communicated and combined with the web applications.

In one embodiment, communicating context between the applications may be performed by taking the raw relational data and translating it into a n-dimensional space. The translated data is then combined across applications and a behavioral mask is applied to it. This behavioral mask is derived from the previous actions that the user and users like that user have taken in the past.

Data components 100 such as those described previously, Desktop 102, Community 104, and Marketview 106, capture contextual data and are combined to form workflow context data 108 to be used in presenting a recommendation to the user 110. An online network management system may also provide event data concerning network events and asset data relating to network assets (e.g. the physical and virtually components and equipment attached to the network).

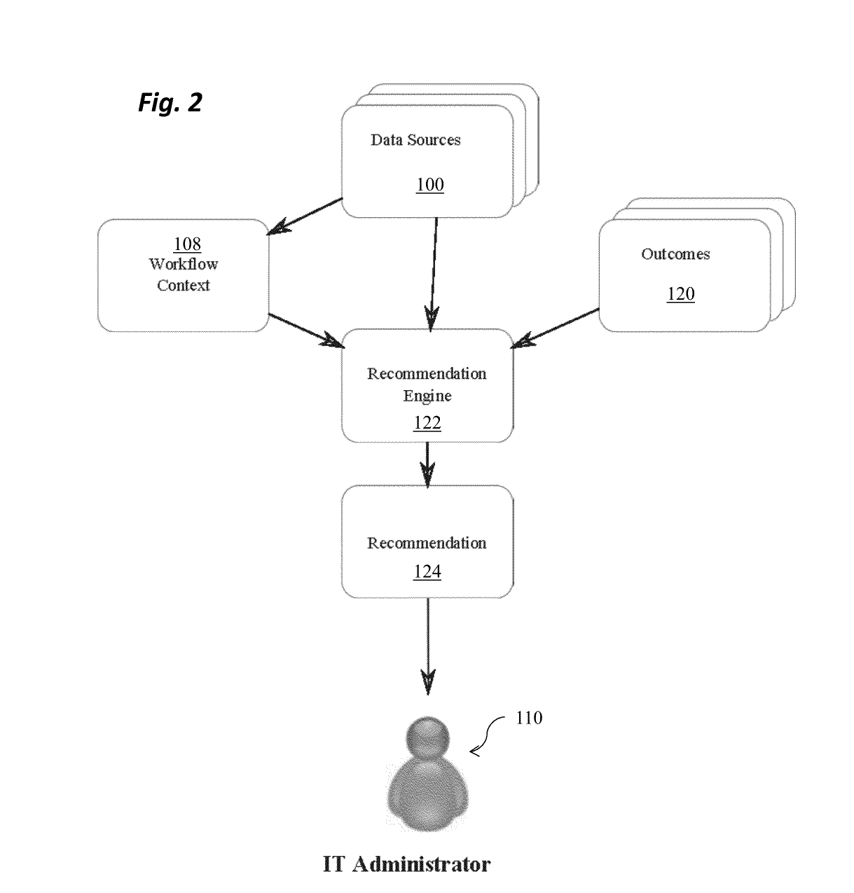

FIG. 2 depicts an embodiment of a system architecture overview for presenting a recommendation to an IT Administrator 110. Data sources 100, such as those of FIG. 1, provide contextual data to create workflow context 108, and also provide event, network asset, and other relational data to a recommendation engine 122. Potential outcomes 120 are also provided to the recommendation engine 122 which then determines a recommendation 124 to present to the user, here an IT Administrator 110.

### Outcomes

Because there is so much data spread out across many environments, traditional recommenders are computationally intractable as an outcome producer cannot map a known set of data to an unknown set of outcomes. Alternatively, the disclosed subject matter provides a well-defined set of outcomes 120 and maps this to a well-known set of data 100 and 108—an approach functionally the reverse of traditional clustering/recommendation systems/methods.

### Types of Recommendation Outcomes

Examples of Purchasing
Purchase a product or service
Connecting users with vendors
Industry buying cycle analysis (people will often buy the same products at the same time)

Examples of Social
Information about how a user fits with an industry or trend
Connecting users with other users
Connecting users with questions they might have
Connecting users with pertinent answered questions
Connecting users with questions they might have answers to

Examples of Environmental
Drawing a conclusion from a set of environmental data
Upgrade information about products on their network
Prioritizing errors and alerts based on past behavior

### Rating/Scoring Recommendations

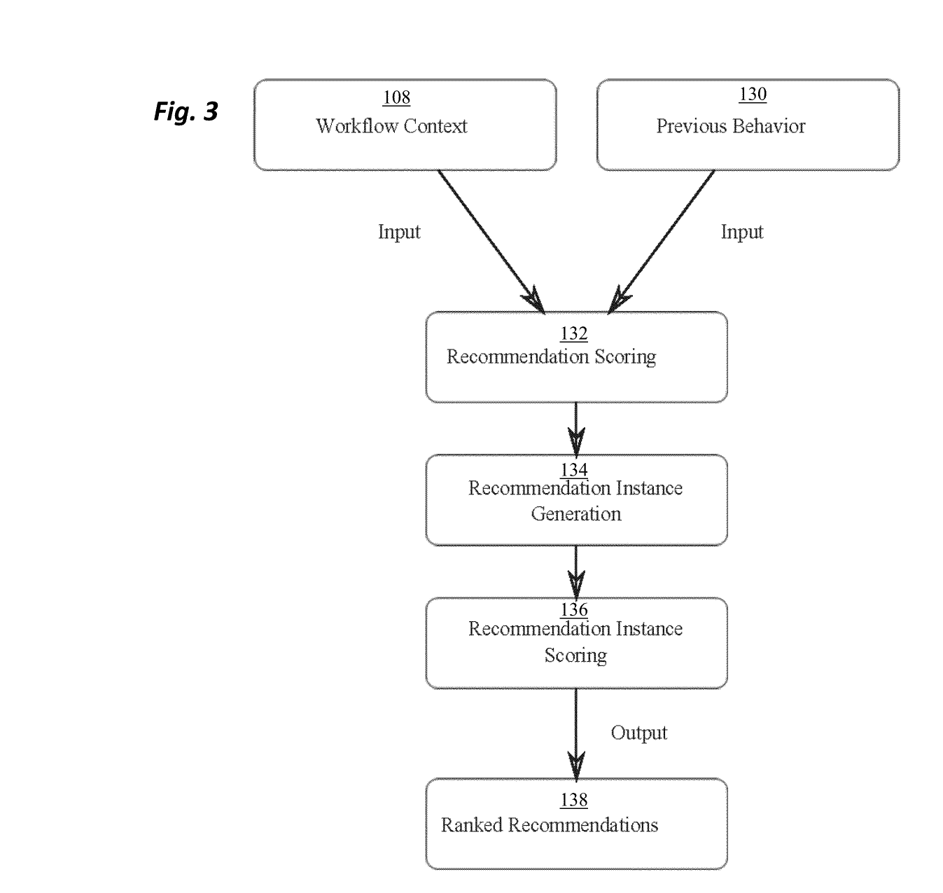

FIG. 3 depicts an embodiment of a system architecture showing the flow of information for rating/scoring recommendations. One aspect of the disclosed subject matter includes automated-tuning recommendations whereby recommendations are provided based on users' actions to previous recommendations for other users 130. A component score of similar users and their preferences is added to pre-guess drift and interest for users that then will be adjusted through further use. This allows, for example, the ability to problem solve using existing network data without user interaction. The recommendation scoring 132 has as inputs workflow context 108 and previous behavior 130. Based on the inputs, the set of possible recommendations is scored. Recommendation instance generation 134 passes off to recommendation instance scoring 136 and outputs the final ranked recommendation. In one embodiment multiple recommendations are provided. In another embodiment, only the highest ranked recommendation is displayed to the user.

### Example Recommendations

For example, operating system adoption happens along an exponential curve. It has a very slow start and an adoption curve different between industries. One major concern of an IT Admin is deciding when is the right time to adopt a new operating system, such as a new version of Windows® (a registered trademark of Microsoft Corporation). Using contextual and relational information, the disclosed subject matter may recommend to an IT Admin to adopt a new operating system version based on similar companies to that IT Admin and present industry information that will help the IT Admin make a decision. Continuing with this example, if the IT Admin is administrating a network for a law firm sized 25-50, the disclosed subject matter can aggregate information on similar companies (law firms with 25-50 employees) and evaluate when or if other similarly situated companies have already upgraded or are in the process of upgrading. This can provide valuable information to the IT Admin on when to upgrade. As noted earlier, the information related to similarly situated companies can be provided by an online network management system.

As another example, often vendors struggle to find clients who need their solutions and IT Admins struggle to find vendors that have credible solutions that might meet the IT Admins need. By looking at network information and behavioral data vendors may be recommended to users. Continuing with this example, company A is a company that helps manage cloud services; unfortunately, adoption of cloud services has been sporadic and finding potential customers has been difficult. The presently disclosed subject matter can identify current cloud services to recommend to particular users in need of cloud services. A behavioral mask may also be applied to this recommendation which would only recommend Company A to potential purchasers who have used Company A previously. This example uses data from three data sources: the desktop 102, community 104, and marketview 106.

Making correct IT decisions can be difficult; however, by collecting and using network information and behavioral data, situations where an IT Admin is similar or dissimilar to his/her peer group may be identified. Currently, virtualization technology is one of the most important choices IT companies are making; however, the decision to utilize virtualization is a decision that involves completely overhauling the backend of most IT companies. As a result, IT Admins would benefit knowing that their decision is similar to their peers.

Further, many industries operate on predictable buying cycles. By looking at network information and behavioral data, buying cycles may be identified and products recommended to a user.

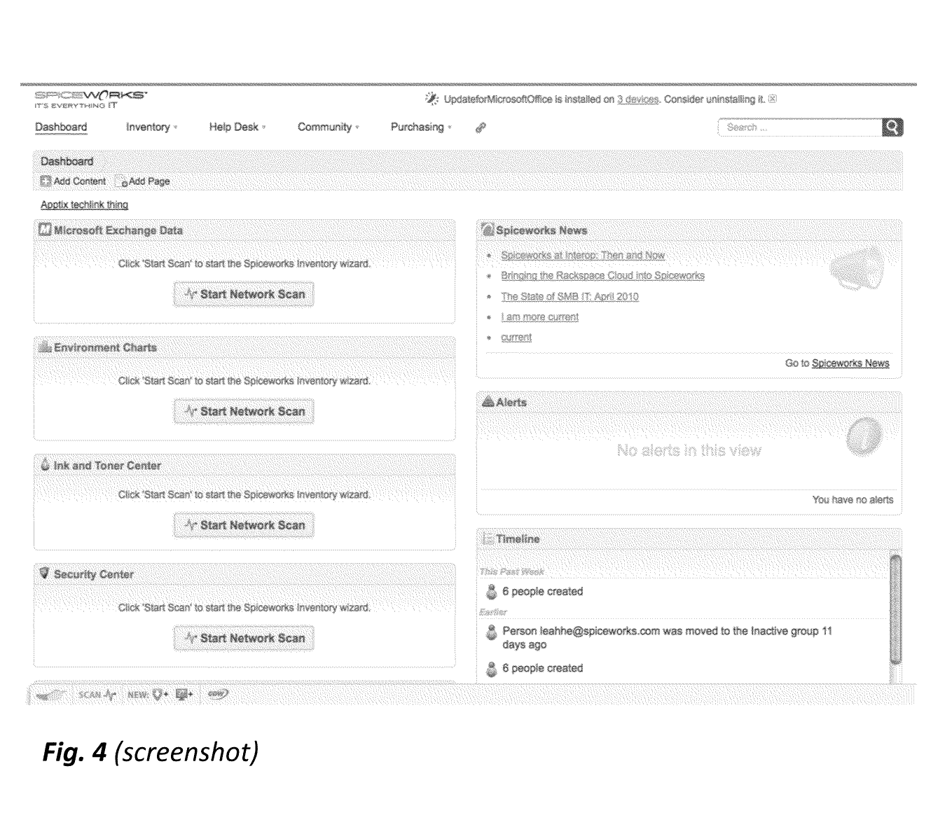

FIGS. 4-11 are screenshots showing aspects of the disclosed subject matter. FIG. 4 depicts an embodiment of a general interface, a “Dashboard,” of an online network management system. The Dashboard allows an IT Admin to monitor and manage a network of IT devices.

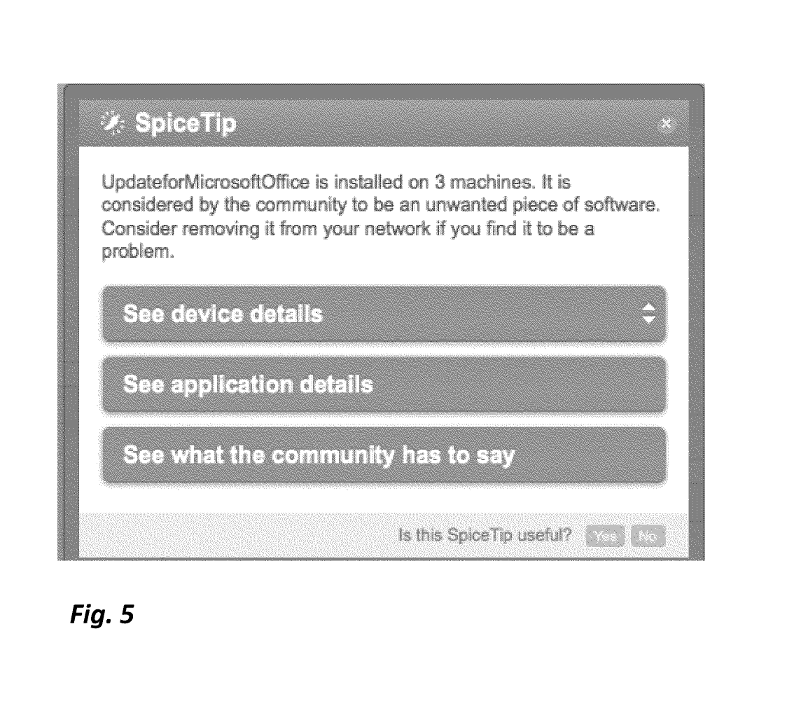

FIG. 5 depicts an embodiment of a Tip, referred to herein also as a recommendation or outcome, presented to the online network management system user. Here, the outcome is to remove a piece of software based on a community of other IT Admins utilizing the online network management system. The recommendation is accompanied by information relating to the recommendation for the user, such as viewing device details about devices with the identified software, application details about the software itself, and community reviews from the online community message board—all designed to provide the user with information to help in deciding whether or not to accept the recommendation. In this particular embodiment, the recommendation is a pop-up screen which automatically displays according to a pre-determined criteria, such as the status of network devices or actions by the user, but the recommendation may also require an opt-in from the user.

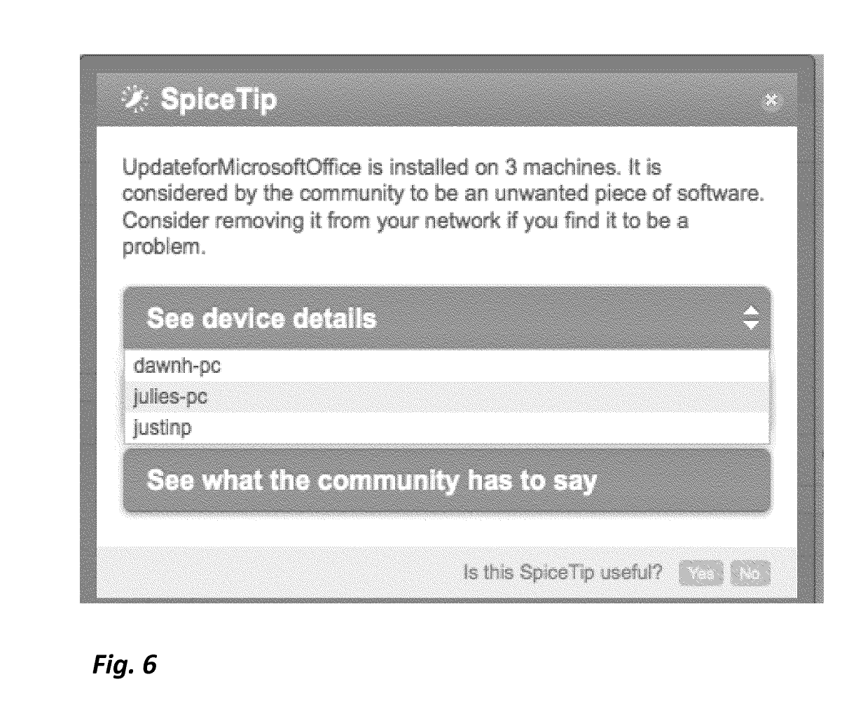

FIG. 6 depicts an embodiment of the See Device Details tab. Here, the user is presented with all the network devices which are currently running the identified software for removal and is able to select a device to see more detailed information.

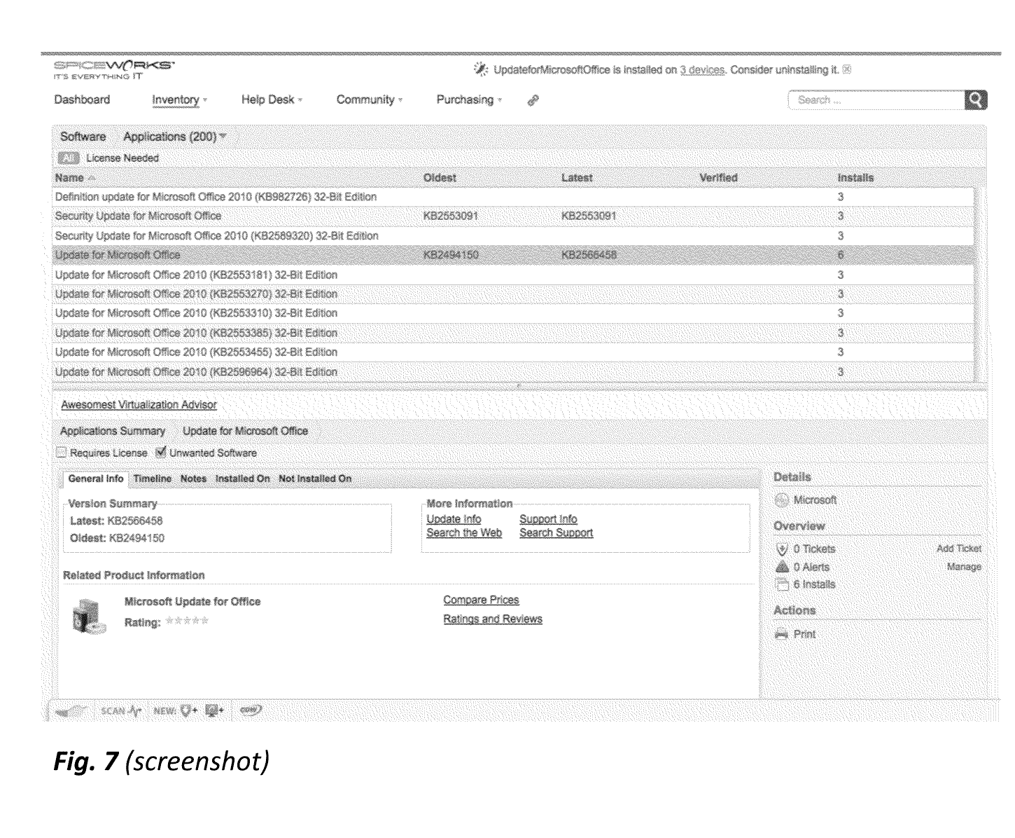

FIG. 7 depicts an embodiment of the See Application Details whereby the user is presented with information relating to the software application.

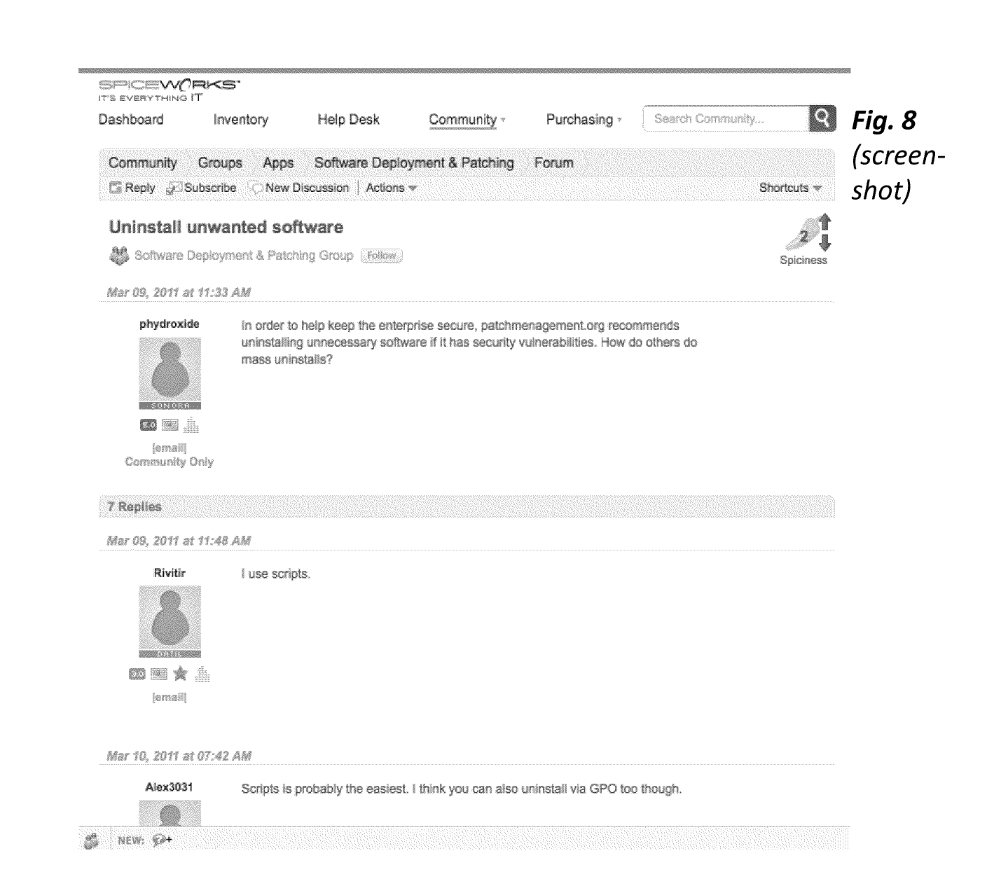

FIG. 8 depicts an embodiment of the community message board posts relating to the Tip of FIG. 5.

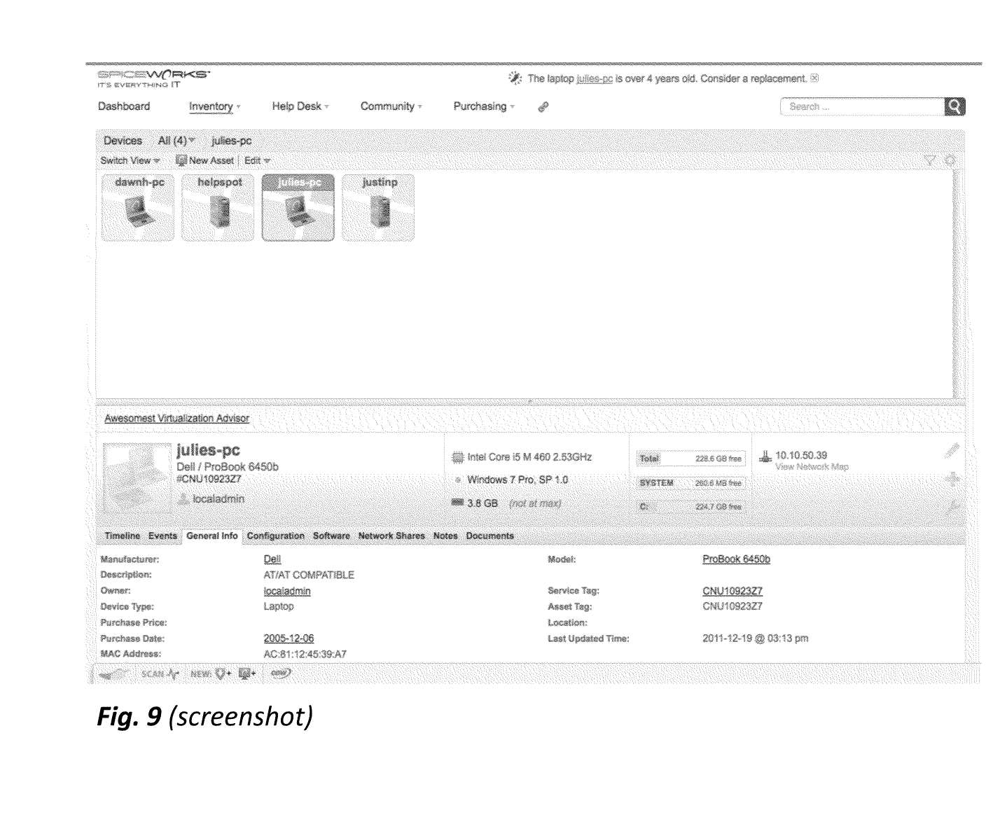

FIG. 9 depicts an embodiment of an Inventory screen displaying all devices and information about all devices on the network.

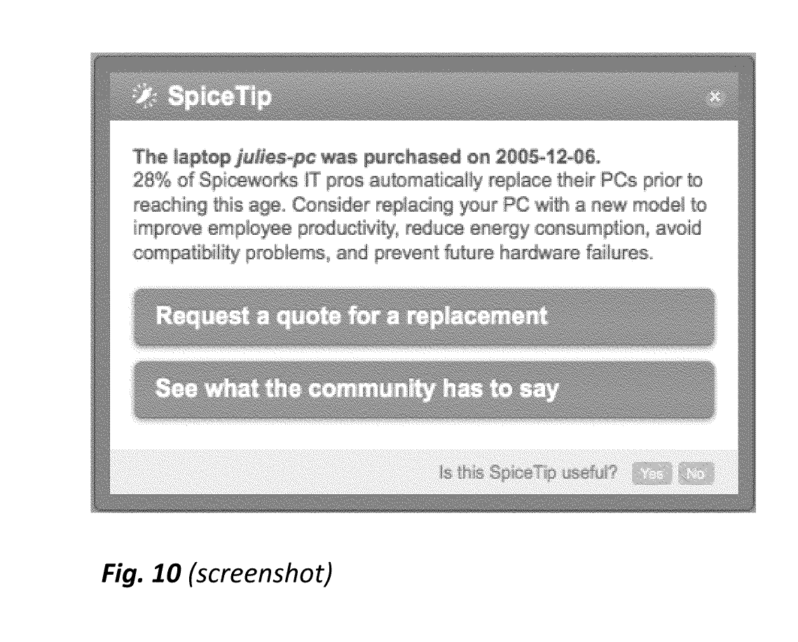

FIG. 10 depicts an embodiment of a Tip presented to a user in a pop-up screen on the Inventory tab. This tip relates to the age of the network device julies-pc, captured by the online network management system, and provides a recommendation based on the actions of similar IT Admins. Here, the user is also provided with a Request for Quote option as well as the ability to search the community message boards for information relating to replacing a pc.

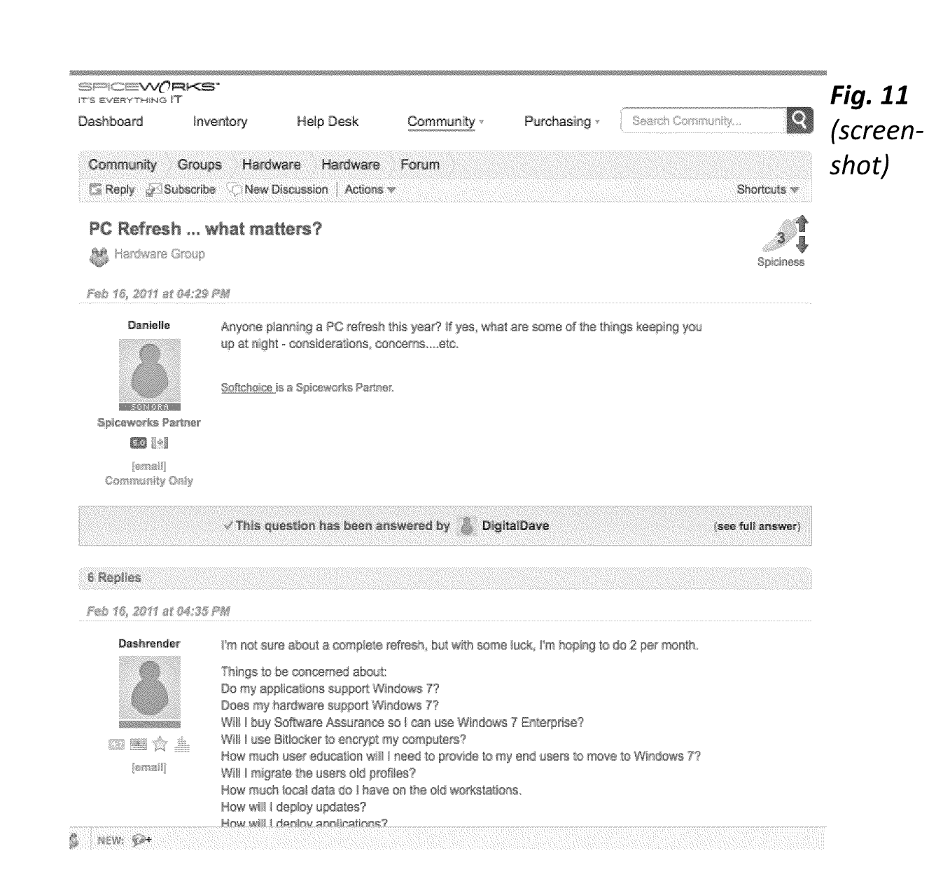

FIG. 11 depicts an embodiment of the community message with exemplary board posts that may be provided to the user after the “See what the community has to say” tab has been selected.

An additional aspect of the disclosed subject matter includes utilizing sentiment tracking in the form of tagging positive and negative posts in the community component. Further, user purchases may be traced backwards to identify relational and contextual data that may have led to the purchase itself. This data may then be tagged as positive or negative and utilized in additional user recommendations.

What is claimed is:

1. A method for a fully integrated information technology (“IT”) recommendation system, the method comprising the following steps:
receiving contextual data, said contextual data comprising information regarding what a user is currently viewing;
receiving relational data, said relational data comprising information regarding said user's previous interaction with an online community, said online community related to IT administrators;
receiving market view data, said market view data comprising industry trend information related to IT, said industry particular to said user's industry, wherein said contextual data, said relational data, and said marketing data is a workflow context;
providing said workflow context to a recommendation engine, wherein said recommendation engine evaluates said workflow context and selects one or more of a set of outcomes, said outcome(s) directly related to said workflow context; and
presenting said one or more selected outcomes to said user.

2. The method of claim 1, additionally comprising the step of receiving event data, said event data comprising information related to said user's network and including one or more of:
status of IT devices on said user's network;
status of software installed on said IT devices on said user's network;

[symbol]

3. The method of claim 1, wherein said outcome includes at least one of:
purchasing outcome, said purchasing outcome including at least one of:
suggesting for said user to purchase an IT product, said IT product directly related to said workflow context;
suggesting for said user to purchase an IT service, said IT service directly related to said workflow context;
connecting said user with one or more vendors, said vendor directly related to said workflow context; and
providing information to said user related to said user's industry's IT
buying cycle related to said workflow context;
social outcome, said social outcome including at least one of:
informing said user as to how said user fits with said industry with respect to said workflow context;
informing said user as to how said user fits within a trend within said industry with respect to said workflow context;
connecting said user with one or more other members of said online community directly related to said workflow context;
connecting said user with questions posted on said online community directly related to said workflow context; and
connecting said user with questions said user may be able to answer that are directly related to said workflow context.

4. The method of claim 3:
additionally comprising the step of receiving environmental data, said environmental data provided by an online network management system and including one or more of:
event data, said event data comprising the status of one or more IT devices on said user's network and including errors and alerts; and
asset data, said asset data comprising one or more IT assets on said user's network;
wherein said environmental data is included in said workflow context; and
said outcome additionally includes environmental outcome, said environmental outcome including at least one of:
drawing a conclusion from a set of said environmental data;
suggesting upgrades, said upgrades directly related to said environmental data; and
prioritizing one or more of said errors and said alerts based on said workflow context.

5. The method of claim 1, wherein said interactions with said online community comprise one or more of:
other online community members the user has connected with;
questions the user has posted to said online community;
surveys the user has initiated on said online community;
questions the user has answered on said online community;
postings the user made on said online community; and
postings the user has read on said online community.

6. The method of claim 1, wherein communication between applications is accomplished by the following steps:
translating said contextual data, said relational data, and said marketing data into a n-dimensional space;
combining said translated data across said applications;
applying a behavioral mask to said translated data, said behavioral mask derived from one or more previous actions of said user and other members of said online community similar to said user.

7. A non-transitory computer readable medium encoded with instructions executable on a processor, the instructions for a fully integrated information technology (“IT”) recommendation system comprising:
a communications medium;
a processor, said processor executing the following steps:
receiving contextual data via said communications medium, said contextual data comprising information regarding what a user is currently viewing;
receiving relational data via said communications medium, said relational data comprising information regarding said user's previous interaction with an online community, said online community related to IT administrators;
receiving market view data via said communications medium, said market view data comprising industry trend information related to IT, said industry particular to said user's industry, wherein said contextual data, said relational data, and said marketing data is a workflow context;
providing said workflow context to a recommendation engine, wherein said recommendation engine evaluates said workflow context and selects one or more of a set of outcomes, said outcome(s) directly related to said workflow context; and
presenting said one or more selected outcomes to said user.

8. The method of claim 7, additionally comprising the step of receiving event data via said communications medium, said event data comprising information related to said user's network and including one or more of:
status of IT devices on said user's network;
status of software installed on said IT devices on said user's network;

[symbol]

9. The method of claim 7, wherein said outcome includes at least one of:
purchasing outcome, said purchasing outcome including at least one of:
suggesting for said user to purchase an IT product, said IT product directly related to said workflow context;
suggesting for said user to purchase an IT service, said IT service directly related to said workflow context;
connecting said user with one or more vendors, said vendor directly related to said workflow context; and
providing information to said user related to said user's industry's IT buying cycle related to said workflow context;
social outcome, said social outcome including at least one of:
informing said user as to how said user fits with said industry with respect to said workflow context;
informing said user as to how said user fits within a trend within said industry with respect to said workflow context;
connecting said user with one or more other members of said online community directly related to said workflow context;
connecting said user with questions posted on said online community directly related to said workflow context; and
connecting said user with questions said user may be able to answer that are directly related to said workflow context.

10. The method of claim 9:
additionally comprising the step of receiving environmental data, said environmental data provided by an online network management system and including one or more of:
event data, said event data comprising the status of one or more IT devices on said user's network and including errors and alerts; and
asset data, said asset data comprising one or more IT assets on said user's network;
wherein said environmental data is included in said workflow context; and
said outcome additionally includes environmental outcome, said environmental outcome including at least one of:
drawing a conclusion from a set of said environmental data;
suggesting upgrades, said upgrades directly related to said environmental data; and
prioritizing one or more of said errors and said alerts based on said workflow context.

11. The method of claim 7, wherein said interactions with said online community comprise one or more of:
other online community members the user has connected with;
questions the user has posted to said online community;
surveys the user has initiated on said online community;
questions the user has answered on said online community;
postings the user made on said online community; and
postings the user has read on said online community.

12. The method of claim 7, wherein communication between applications is accomplished by the following steps:
translating said contextual data, said relational data, and said marketing data into a n-dimensional space;
combining said translated data across said applications;
applying a behavioral mask to said translated data, said behavioral mask derived from one or more previous actions of said user and other members of said online community similar to said user.
